(19) United States
(12) Patent Application Publication
(10) Pub. No.: US 2023/0109075 A1
(43) Pub. Date: Apr. 6, 2023

(54) METHOD FOR DYNAMICALLY UPDATING A PROJECT PLAN USING AN AI MODEL AND HISTORICAL DATA

(71) Applicant: Lean Station Pte. Ltd, Singapore (SG)

(72) Inventors: Sharath Waikar, Singapore (SG); Santhosh N. Sadanandan, Bangalore (IN); Rohith Vishwanath, Bangalore (IN); Nguyen Thi Qui, Singapore (SG)

(21) Appl. No.: 17/495,736

(22) Filed: Oct. 6, 2021

(51) Int. Cl. G06Q 10/06; G06N 20/00; G06F 40/40

(52) U.S. Cl. CPC G06Q 10/06313; G06N 20/00; G06F 40/40

(57) ABSTRACT

A method for dynamically updating a project plan using natural language processing (NLP) and artificial intelligence (AI) model is provided. The method includes, (i) obtaining master schedule that includes category of a work, and location of the work, and object being worked on, (ii) identifying similar works using the NLP to associate with work cycle, (iii) training AI model by correlating a historical data of changes in the project plan and reasons for the changes in the project plan, (iv) suggesting, using the NLP, applicable work sequence breakdown templates, (v) obtaining a selection of the applicable work sequence breakdown templates from user, (vi) updating the project plan based on selected work sequence breakdown template, (vii) dynamically updating the project plan across works associated with work cycle when there is a change to works, and (viii) dynamically updating the project plan using the NLP and trained AI model based on the change to works.

### BACKGROUND

### Technical Field

Embodiments of the disclosure generally relate to the field of artificial intelligence (AI), and more specifically, to dynamically updating a project plan using natural language processing and an artificial intelligence (AI) model.

### Description of the Related Art

A construction project is an organized process of constructing, renovating, refurbishing a building, a structure, or an infrastructure. Typically, a construction project includes a wide range of different disciplines working in collaboration. Also, the construction project requires multiple inputs to generate a reliable plan that can be executed by the site team. The root causes of arriving at a reliable plan include experiential knowledge of construction works, understanding of site requirements, predicaments, the anticipation of upcoming challenges, and information from past performance of similar works within the project itself. With all these multiple variables and its lack of timely availability, it is possibly a huge challenge for an engineer to work out a construction plan reliably. The problem is amplified by executing the construction plan with fresh engineers who have limited working experience in construction sites. In addition to this, any changes in the construction plan at the site due to dynamic site conditions and the imminent need for other stakeholders' involvement in providing other related variables that are needed for a reliable plan are also often not satisfied due to its complexity and challenges.

The master schedule created at the beginning of the construction project includes activities at a high-level work breakdown structure. For execution, a project team needs to further break these activities down into the lower level of details (tasks). This process requires the team to have sufficient knowledge and experience of the related work to ensure the specified sequences and durations are reliable and can be carried out on site. To gather sufficient information to generate a good plan, there needs to be a collective involvement of multiple teams for collective knowledge and experiences to decide on the method/approach to take, resource allocation, preparation, technical design and requirements, and so on. This team-effort requirement makes construction planning tough at sites, especially when projects are in a delayed stage. As a result, planning has gradually taken a backseat. While unreliable planning is one of the reasons for project delays and costs overruns in construction, current planning practices at a site do not help the project team, and needs to be transformed to be more efficient.

The ability to execute based on a construction plan is affected immensely due to dynamic conditions at the site. The factors affecting the execution may change drastically during execution than when it was planned for. The fluctuating working conditions and rapidly changing parameters based on the working conditions at the site needs to be considered. Thus, planning for construction needs to be agile to cater to such dynamic conditions at the site. These can easily include changes in technical requirements/designs, late material delivery, unavailability or shortage of manpower, breakdown of key resources, unexpected site conditions, or adverse weather situations. Predicting potential changes based on similar situations in the past requires a big effort of recording and analyzing past data. The recording and analyzing of large volumes of past data that is used for prediction along with consideration of fluctuating working conditions and rapidly changing parameters is quiet challenging even for an experienced engineer. Although this analysis can be done and is currently done manually, the challenges are the timely processing when needed and its reliability due to missing and/or delayed information. It also requires a huge effort for a human brain to analyze and detect potential patterns of a big set of data of a project, from which the project team can learn and improve in subsequent similar works. As a consequence, when construction plans generated at the beginning of the project become more and more unrealistic, the team has no choice but to just keep doing whatever they can, report issues, and move on to the next job in a reactive manner.

Constraint is a condition or a force that limits systems' performance in a given environment. The constraints may include economic constraints, environmental constraints, technical constraints, social constraints etc. In current practice, planning and managing constraints are usually done through meeting discussions and manual recordings, which may lead to missing crucial issues. The fact that completing these constraints usually contributes low or no value to the claim value and is highly dependent on other stakeholders, making them neglected or not well managed. In addition, due to the complex inter-dependencies between different construction works, it is tough for one to visualize and determine the robust chain of crucial events from the constraints to the site works. Therefore, there is an urgent need for a more effective mechanism to support the construction team in handling hidden crucial issues for better executing the project.

Existing techniques employ building information model (BIM) generation of resource planning with schedule options using applied construction methods and the relationship between BIM elements. The existing techniques fail to identify changes in a plan and suggest places where such changes can be applied. The existing techniques fail to identify missing constraints in a plan and suggest places where these constraints can also be applied.

Accordingly, there remains a need for a more efficient method for mitigating and/or overcoming drawbacks associated with current methods and systems in generating a project plan for a building.

### SUMMARY

In view of the foregoing, there is provided a processor-implemented method for dynamically updating a project plan using natural language processing and an artificial intelligence (AI) model. The method includes obtaining a master schedule that includes (a) at least one category of a work, and at least one location of the work, and (b) at least one object being worked on with the at least one location of the work. The at least one category of the work, the at least one location of the work and the at least one object being worked on are represented in a hierarchy. The method includes identifying one or more similar works using the natural language processing to associate with a work cycle. The method includes training the AI model by correlating a historical data of changes in the project plan and one or more reasons for the changes in the project plan to obtain a trained AI model. The historical data of changes in the project plan is stored in a knowledge base. The method includes suggesting, using the natural language processing, one or more applicable work sequence breakdown templates based on the at least one category of the work, the at least one location of the work, at least one change in the project plan and the historical data of changes in the project plan. The method includes obtaining a selection of at least one of one or more applicable work sequence breakdown templates from the user to obtain a selected work sequence breakdown template. The method includes updating the project plan based on the selected work sequence breakdown template. The method includes dynamically updating the project plan across one or more works associated with the work cycle when there is a change to at least one of the plurality of works. The method includes dynamically updating the project plan using the natural language processing and the trained AI model based on the change to the at least one of the one or more works.

In some embodiments, the processor-implemented method includes, identifying, using the natural language processing, at least one common structure type in a plurality of locations to group into the work cycle.

In some embodiments, the processor-implemented method includes obtaining at least one BIM component associated with the at least one category of the work from the master schedule to suggest the plurality of applicable work sequence breakdown templates using the natural language processing.

In some embodiments, the project plan includes an estimated duration of completion of the work associated with the at least one location of the work, a production rate for the work associated with the at least one location. The estimated duration of completion of the work is updated based on the trained AI model based on the change to the at least one of one or more works.

In some embodiments, the historical data of changes in the project plan include at least one of a change in the work, a new task in the work cycle, a new constraint to a future task along with a schedule, changes in the schedule with possible space availability issues, delays due to planning errors, or a production rate for the task associated with the at least one location.

In some embodiments, the processor-implemented method includes ranking the suggested one or more applicable work sequence breakdown templates based on a relevance obtained from the natural language processing of the at least one category of the work, and the at least one location of the work obtained from the master schedule.

In some embodiments, the processor-implemented method the AI model is trained based on a historical data of a time schedule overlap among works of same location of the work, wherein the method further includes dynamically updating the project plan based on space availability, using the trained AI model, with a notification is the time schedule overlap among works of the same location of the work.

In some embodiments, the processor-implemented method includes dynamically updating the project plan, using the trained AI model, when the production rate for the work associated with the at least one location is applied to the work cycle by aggregating the production rate of the similar works in the work cycle.

In some embodiments, the processor-implemented method includes providing, using a planning effectiveness indicator, a suggestion to the user when there are delays due to planning errors by grouping the delays based on the at least one category of the work. The planning effectiveness indicator includes a percentage of activities that are completed within a planned duration by the at least one category of the work, and a percentage of activities where start dates were delayed by the at least one category of the work with suggestions on planning improvements.

In one aspect, there is provided a system for dynamically updating a project plan using natural language processing and an artificial intelligence (AI) model. The system includes a memory that stores a set of instructions and a processor that is configured to execute the set of instructions, which when executed by the processor causes one or more functions of the system. The system performs to (i) obtain a master schedule that includes (a) at least one category of a work, and at least one location of the work, and (b) at least one object being worked on with the at least one location of the work. The at least one category of the work, the at least one location of the work and the at least one object being worked on are represented in a hierarchy, (ii) identify one or more similar works using the natural language processing to associate with a work cycle, (iii) train the AI model by correlating a historical data of changes in the project plan and one or more reasons for the changes in the project plan to obtain a trained AI model. The historical data of changes in the project plan is stored in a knowledge base, (iv) suggest, using the natural language processing, one or more applicable work sequence breakdown templates based on the at least one category of the work, the at least one location of the work, at least one change in the project plan and the historical data of changes in the project plan, (v) obtain a selection of at least one of one or more applicable work sequence breakdown templates from the user to obtain a selected work sequence breakdown template, (vi) update the project plan based on the selected work sequence breakdown template, (vii) dynamically updating the project plan across one or more works associated with the work cycle when there is a change to at least one of the plurality of works, and (vii) dynamically updating the project plan using the natural language processing and the trained AI model based on the change to the at least one of the plurality of works.

In some embodiments, the project plan includes an estimated duration of completion of the work associated with the at least one location of the work, a production rate for the work associated with the at least one location. The estimated duration of completion of the work is updated based on the trained AI model based on the change to the at least one of one or more works.

In some embodiments, the historical data of changes in the project plan comprise at least one of a change in the work, a new task in the work cycle, a new constraint to a future task along with a schedule, changes in the schedule with possible space availability issues, delays due to planning errors, or a production rate for the task associated with the at least one location.

In some embodiments, the processor is further configured to include dynamically updating the project plan using the natural language processing and the trained AI model based on the change to the at least one of the one or more works.

In some embodiments, the processor is further configured to include ranking the suggested plurality of applicable work sequence breakdown templates based on a relevance obtained from the natural language processing of the at least one category of the work, and the at least one location of the work obtained from the master schedule.

In some embodiments, the processor is further configured to include training the AI model based on a historical data of a time schedule overlap of the work with another work at same location of the work, wherein the method further comprises dynamically updating the project plan based on space availability, using the trained AI model, with a notification when there is the time schedule overlap between works of the same location of the work.

In some embodiments, the processor is further configured to include dynamically updating the project plan, using the trained AI model, when the production rate for the work associated with the at least one location is applied to the work cycle by aggregating the production rate of the similar works in the work cycle.

In some embodiments, the processor is further configured to include providing, using a planning effectiveness indicator, a suggestion to the user when there are delays due to planning errors by grouping the delays based on the at least one category of the work, wherein the planning effectiveness indicator includes a percentage of activities that are completed within a planned duration by the at least one category of the work, and a percentage of activities where start dates were delayed by the at least one category of the work with suggestions on planning improvements.

In some embodiments, the processor is further configured to include obtaining at least one BIM component associated with the at least one category of the work from the master schedule.

In another aspect, there is provided one or more non-transitory computer-readable storage mediums storing one or more sequences of instructions, which when executed by one or more processors, causes a method of for dynamically updating a project plan using natural language processing and an artificial intelligence (AI) model. The method includes (i) obtain a master schedule that includes (a) at least one category of a work, and at least one location of the work, and (b) at least one object being worked on with the at least one location of the work. The at least one category of the work, the at least one location of the work and the at least one object being worked on are represented in a hierarchy, (ii) identify one or more similar works using the natural language processing to associate with a work cycle, (iii) train the AI model by correlating a historical data of changes in the project plan and one or more reasons for the changes in the project plan to obtain a trained AI model. The historical data of changes in the project plan is stored in a knowledge base, (iv) suggest, using the natural language processing, one or more applicable work sequence breakdown templates based on the at least one category of the work, the at least one location of the work, at least one change in the project plan and the historical data of changes in the project plan, (v) obtain a selection of at least one of one or more applicable work sequence breakdown templates from the user to obtain a selected work sequence breakdown template, (vi) updating the project plan based on the selected work sequence breakdown template, (vii) dynamically updating the project plan across the plurality of works associated with the work cycle when there is a change to at least one of the plurality of works, and (vii) dynamically updating the project plan using the natural language processing and the trained AI model based on the change to the at least one of the plurality of works. The system and method for generating a project plan of a building using a knowledge base of an artificial intelligence (AI) model are provided. The system develops an AI-based expert to build an initial knowledge graph from reliable data in the construction context and expert domain knowledge. The system improves the initial knowledge graph by combining project-specific information to provide suggestions. The system achieves to find a pattern from the available data of construction projects using the AI-based expert. The AI-based expert recognizes patterns of unique construction projects and provides customized suggestions using minor variations on the data. The system improves accuracy in prediction over gradual usage in other industries such as shipyard, production, oil, and gas, etc.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a system for dynamically updating a project plan using natural language processing (NLP) and an artificial intelligence (AI) model according to some embodiments herein;

FIG. 2 illustrates a block diagram of the server of FIG. 1 for dynamically updating a project plan using natural language processing and an artificial intelligence (AI) model 110 according to some embodiments herein;

FIG. 3 is an exemplary representation of a category of work, and a work cycle according to some embodiments herein:

FIG. 4 is an exemplary representation of a detailed preview of a project plan based on selected work sequence breakdown template according to some embodiments herein;

FIG. 5 is an exemplary representation of a recommendation of the trained AI model according to some embodiments herein;

FIGS. 6A-6B are flow diagrams that illustrate a method for dynamically updating a project plan using natural language processing and an artificial intelligence (AI) model according to some embodiments herein; and

FIG. 7 is a schematic diagram of a computer architecture in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

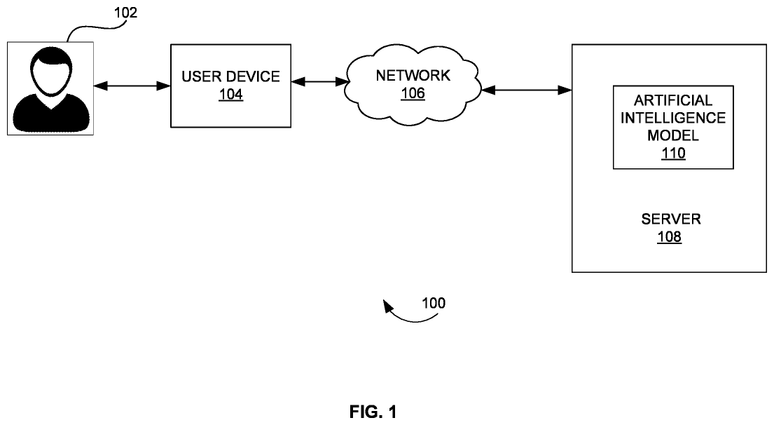

Various embodiments disclosed herein provide a system and a method for generating a project plan of a building using a knowledge base of an AI model, to predict the project plan of the building using the AI model. Referring now to the drawings, and more particularly to FIGS. 1 through 7, where similar reference characters denote corresponding features consistently throughout the figures, preferred embodiments are shown.

FIG. 1 is a block diagram that illustrates a system 100 for dynamically updating a project plan using natural language processing (NLP) and an artificial intelligence (AI) model 110 according to some embodiments herein. The system 100 includes a server 108, and a user device 104 associated with a user 102. The server 108 includes the AI model 110. A list of devices that are capable of functioning as the server 108, without limitation, may include one or more of a personal computer, a laptop, a tablet device, a smartphone, a mobile communication device, a personal digital assistant, or any other such computing device. In some embodiments, the user device 104, without limitation, is selected from a personal computer, a laptop, a tablet device, a smartphone, a mobile communication device, a personal digital assistant, or any other such computing device. The server 108 may communicate with the user device 104 through a network 106. In some embodiments, the network 106 is a wireless network. In some embodiments, the network 106 is a combination of the wired network and the wireless network. In some embodiments, the network 106 is the Internet.

The server 108 obtains a master schedule that includes (a) at least one category of a work, and at least one location of the work, and (b) at least one object being worked on with the at least one location of the work. The at least one category of the work, the at least one location of the work and the at least one object being worked on are represented in a hierarchy.

In some embodiments, the server 108 obtains at least one BIM component associated with the at least one category of the work from the master schedule.

The master schedule may be a detailed project schedule that highlights one or more activities and milestones on an entire project calendar. The master schedule includes one or more activities involved in the project plan of the building. The master schedule is a high-level work breakdown structure along with timelines. For example, to execute the master schedule, a project team needs to further divide one or more activities into the lower level of details that are tasks along with time schedules. For example, a structural activity “2nd Floor” in the master schedule needs to be divided into a sequence of tasks on sites as “Install Formwork”, “Placing rebar” and “Concrete Casting”.

The at least one BIM component is defined as a volume of the distinct geometrical shape, a surface area of the distinct geometrical shape, a length of the distinct geometrical shape etc.

The knowledge base includes libraries of texts that describe one or more works. Each work may be referred as a combination of one or more tasks for executing the project plan of the building. Each task is referred as a single unit of work. The tasks, may include, but not limited to, place formwork, place steel, pour concrete, dry concrete, remove formwork, etc.

The server 108 includes a database. The database is integrated with a knowledge base of the AI model 110.

The text of a hierarchy of the work in the master schedule may be processed using a natural language processing (NLP). The server 108 identifies one or more similar works using the NLP to associate with a work cycle. The server 108 trains the AI model 110 by correlating a historical data of changes in the project plan and one or more reasons for the changes in the project plan to obtain a trained AI model. The historical data of changes in the project plan is stored in a knowledge base. The historical data of changes in the project plan include at least one of a change in the work, a new task in the work cycle, a new constraint to a future task along with a schedule, changes in the schedule with possible space availability issues, delays due to planning errors, or a production rate for the task associated with the at least one location.

The server 108 suggests, using the NLP, one or more applicable work sequence breakdown templates based on the at least one category of the work, the at least one location of the work, at least one change in the project plan and the historical data of changes in the project plan.

The server obtains a selection of at least one of one or more applicable work sequence breakdown templates from the user to obtain a selected work sequence breakdown template. The server 108 updates the project plan based on the selected work sequence breakdown template. The work sequence breakdown template includes at least one of task list, sequence dependencies, and associated constraints. The task list may be a list of specific tasks assigned to a task and the timelines for completing the specific tasks, for example, place formwork for 10 days, remove formwork for 10 days. The sequence is defined as an arrangement of one or more activities in an order. During sequencing of one or more activities, there may be one or more dependencies among the one or more activities which may be known as sequence dependencies. For example, an intermediary activity for a slab work like pour concrete is sequentially dependent on another activity like place steel. The sequential dependencies may be length of the slab, surface area of the slab, etc. for both activities of pour concrete and place steel. The associated constraints for one or more activities like pour concrete may include environmental constraints like wastage of concrete while pouring and wastage of concrete leads to an excess of waste in landfills resulting in a disastrous effect.

The server 108 dynamically updates the project plan across one or more works associated with the work cycle when there is a change to at least one of one or more works.

The server 108 dynamically updates the project plan using the natural language processing and the trained AI model based on the change to the at least one of the plurality of works. The project plan includes an estimated duration of completion of the work associated with the at least one location of the work, a production rate for the work associated with the at least one location. The estimated duration of completion of the work is updated based on the trained AI model based on the change to the at least one of one or more works.

The knowledge base also includes libraries of texts describing historical works. The historical works may be place formwork, place steel, pour concrete, dry concrete, remove formwork, etc.

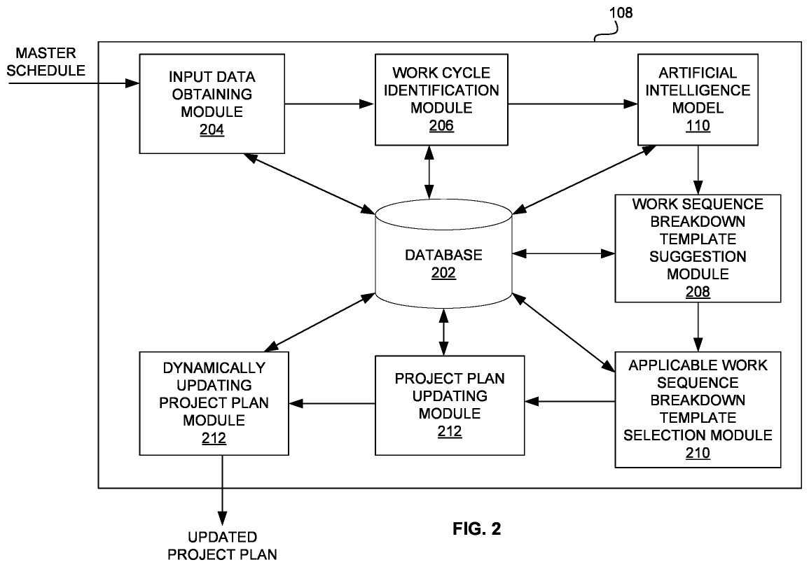

FIG. 2 illustrates a block diagram that illustrates a server 108 for dynamically updating a project plan using natural language processing and an artificial intelligence (AI) model 110 of FIG. 1 according to some embodiments herein. The server 102 includes a database 202, a input data obtaining module 204, a work cycle identification module 206, a work sequence breakdown template suggestion module 208, a applicable work sequence breakdown template selection module 210, a project plan updating module 212, and a dynamically updating project plan module 214. The database 202 may be communicatively connected with one or more modules of the server 108. The database 202 is integrated with a knowledge base of the AI model 110. The knowledge base includes libraries of texts that describe one or more works.

The input data obtaining module 204 receives a master schedule that includes (a) at least one category of a work, and at least one location of the work, and (b) at least one object being worked on with the at least one location of the work. The at least one category of the work, the at least one location of the work and the at least one object being worked on are represented in a hierarchy.

The work cycle identification module 206 identifies one or more similar works using the natural language processing to associate with a work cycle.

The AI model 110 is trained by correlating a historical data of changes in the project plan and one or more reasons for the changes in the project plan to obtain a trained AI model. The historical data of changes in the project plan is stored in a knowledge base.

The work sequence breakdown template suggestion module 208 suggests, using the natural language processing, one or more applicable work sequence breakdown templates based on the at least one category of the work, the at least one location of the work, at least one change in the project plan and the historical data of changes in the project plan.

The applicable work sequence breakdown template selection module 210 obtains a selection of at least one of one or more applicable work sequence breakdown templates from the user to obtain a selected work sequence breakdown template. The applicable work sequence breakdown template selection module 210 ranks the suggested plurality of applicable work sequence breakdown templates based on a relevance obtained from the natural language processing of the at least one category of the work, and the at least one location of the work obtained from the master schedule.

The project plan updating module 212 updates the project plan based on the selected work sequence breakdown template. The dynamically updating project plan module 214 dynamically updates the project plan across the plurality of works associated with the work cycle when there is a change to at least one of the plurality of works. The dynamically updating project plan module 214 dynamically updates the project plan using the natural language processing and the trained AI model based on the change to the at least one of the one or more works. The dynamically updating project plan module 214 dynamically updates the project plan, using the trained AI model, when the production rate for the work associated with the at least one location is applied to the work cycle by aggregating the production rate of the similar works in the work cycle.

The dynamically updating project plan module 214 provides, using a planning effectiveness indicator, a suggestion to the user when there are delays due to planning errors by grouping the delays based on the at least one category of the work. The planning effectiveness indicator includes a percentage of activities that are completed within a planned duration by the at least one category of the work, and a percentage of activities where start dates were delayed by the at least one category of the work with suggestions on planning improvements.

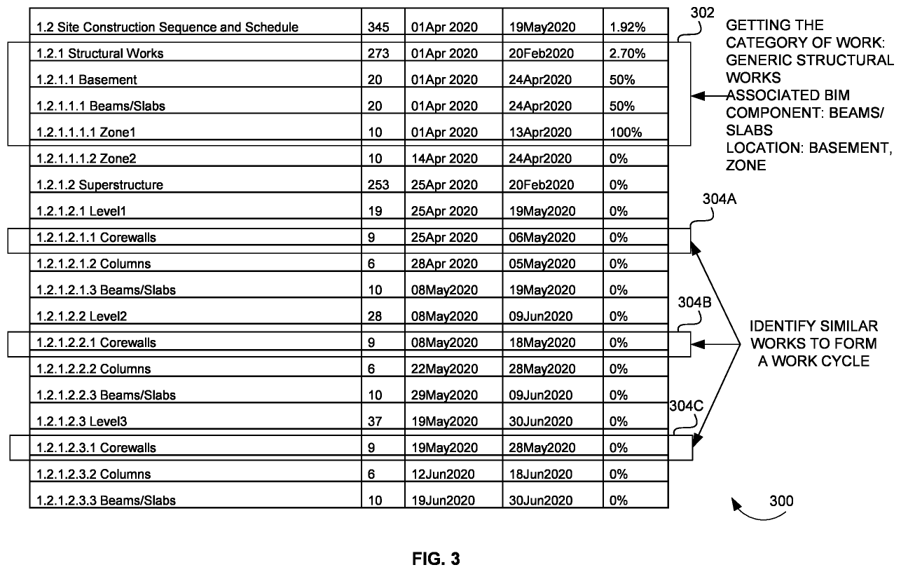

FIG. 3 is an exemplary representation 300 of a category of work, and a work cycle according to some embodiments herein. The exemplary representation 300 includes sequences in work sequence breakdown, estimated duration, a start date of the estimated duration, an end date of the estimated duration, and progress of work. The progress of work may be a percentage of completed work. For example, the exemplary representation 300 depicts the sequences in the work sequence breakdown at a construction site as “Structural works->Basement->Beams/Slabs->Zone1”. For example, the sequences in the work sequence breakdown depict structural works at basement, for a BIM component beams/slabs at Zone1. For example, the estimated duration for structural works at “Basement” maybe 20 working days whose start date is 1 Apr. 2020 and the end date is 24 Apr. 2020 as depicted in the FIG. 3. For example, the progress of work for structural works at basement is 50% as depicted in the FIG. 3. The exemplary representation 300 depicts structural works as the category of the work, beams/slabs as the associated structure and basement, zone 1 as the location of the work at 302.

The exemplary representation 300 of the work cycle depicts identical works, that is corewalls at 304A, 304B, 304C. The identical works are identified in the master schedule using the natural language processing to associate with the work cycle.

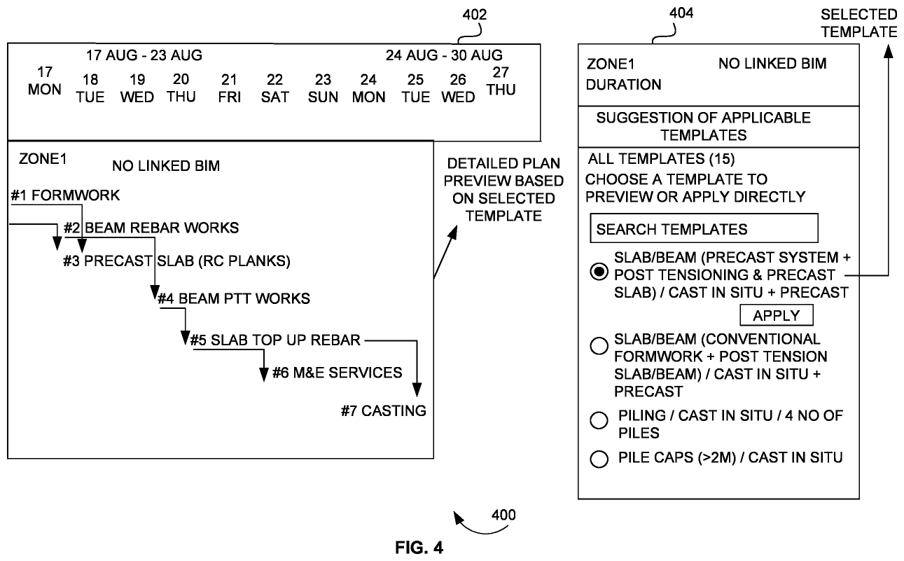

FIG. 4 is an exemplary representation 400 of a detailed preview of a project plan based on a selected work sequence breakdown template according to some embodiments herein. The exemplary representation 400 depicts the detailed preview of the project plan at zone1 at 402 that includes work sequence breakdown, for example, beam rebar works followed by, precast slab (RC planks) followed by, beam PTT works followed by, slab top-up rebar followed by, M&E services followed by casting. For example, consider a breakdown, “Structural works->Basement->Beams/Slabs->Zone1”. The sequences in the work sequence breakdown depict structural works at basement, for a BIM component beams/slabs at Zone1. A weightage is provided for each element in the category of the work, the object being worked on and the location of the work. For example, the weightage for beams/slabs may be 0.5, and the weightage for structural works and the basement, zone 1 may be 0.25. Based on the weightage, the suggested applicable work sequence breakdown templates are filtered, sorted, and ranked based on the maximum weighted applicable work sequence breakdown templates as first and displayed to the user for selection.

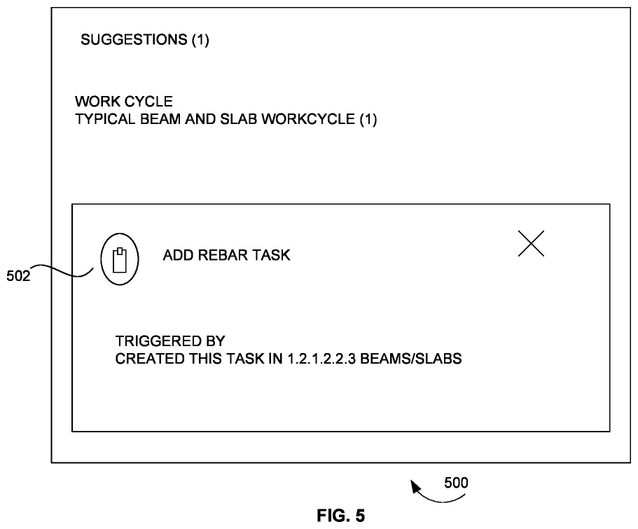

The exemplary representation 400 depicts the selected work sequence breakdown template at 404. The exemplary representation 400 depicts 15 work sequence breakdown templates at zone1 at 404. For example, the work sequence breakdown templates at zone1 that are available at 404 are slab/beam (precast system+post tensioning beam and precast slab)/cast in situ+precast, slab/beam (conventional formwork+post tension slab/beam/cast in situ, piling/cast in situ/4 number of piles, pile caps (>2 m)/cast in situ, pile caps (<2 m)/cast in situ. The total weightage of work breakdown sequence templates slab/beam (precast system+post tensioning beam and precast slab)/cast in situ+precast, slab/beam (conventional formwork+post tension slab/beam/cast in situ may be (0.5+0.2+0)=0.75, whereas the total weightage of work breakdown sequence templates piling/cast in situ/4 number of piles, pile caps (>2 m)/cast in situ, pile caps (<2 m)/cast in situ may be (0+0.25+0)=0.25 each. The suggested work breakdown sequence templates are ranked and displayed to the user based on the total weightage scores of each. FIG. 5 is an exemplary representation 500 of a recommendation of the trained AI model 110 according to some embodiments herein. The exemplary representation 500 depicts the recommendation of the trained AI model by analyzing a new task in a work cycle, for example, rebar task in the typical beam and slab work cycle as depicted in the FIG. 5. The recommendation of the new task, that is rebar task, is generated by showing a message as “triggered by, created this task in 1.2.1.2.2.3 beams/slabs” at 502. For example, in a high-rise building with multiple repetitive typical storeys, when there is a change in the sequence of work in Storey #3 due to a change in construction method, it is highly possible that the same change may be applied to other similar storeys in the future, and thus the original plan of future works needs to be changed to adapt to the new method. Identifying and incorporating the changes is important to ensure the reliability and executability of the plan.

The trained AI model 110 provides, using a planning effectiveness indicator, a suggestion to the user when there are delays due to planning errors by grouping the delays based on the at least one category of the work. The planning effectiveness indicator includes a percentage of activities that are completed within a planned duration by the at least one category of the work, and a percentage of activities where start dates were delayed by the at least one category of the work with suggestions on planning improvements.

For example, consider the works depicted in the following Table 1.

TABLE 1

| Nature of work | Planner | Delay | Delay Reason |
|---|---|---|---|
| Basement Slab | User X | Yes | Material not available |
| First Floor Slab | User X | Yes | Material not available |
| Second Floor Slab | User X | Yes | Permit not available |
| Third Floor Slab | User Y | No | |
| Basement Beam | User X | Yes | Material not available |
| First Floor Bearn | User Y | Yes | Pennit not available |
| Second Floor Beam | User X | Yes | Permit not available |
| Third Floor Beam | User X | Yes | Permit not available |

TABLE 2

| | Nature, | | Count of |
|---|---|---|---|
| Delay Reason | of work | Planner | cases |
| Material not available | Slab | User X | 2 |
| Permit not available | Slab | User Y | 1 |
| Material not available | Beam | User X | 1 |
| Permit not available | Beam | User X | 2 |
| Permit not available | Beam | User Y | 1 |

The trained AI model 110 suggests improvements based on the planning effectiveness indicator as shown in Table 3.

TABLE 3

| | Nature of | |
|---|---|---|
| Delay Reason | work | Improvement |
| Material not available | Slab | Add a material constraint |
| Material not available | Beam | Add a material constraint |
| Permit not available | Beam | Add a technical |
| | | permit constraint |

The AI model 110 is trained based on a historical data of a time schedule overlap of the work with another work at same location of the work. The project plan is dynamically updated based on space availability, using the trained AI model, with a notification when there is the time schedule overlap between works of the same location of the work.

For example, consider the following work sequence breakdown of Table 4.

TABLE 4

| Activity | Start Date | End Date |
|---|---|---|
| Level 1 Stairway Wall | Jan. 01, 2022 | Jan. 02, 2022 |
| Surface Preparation | | |
| Level 1 Stairway Wall | Jan. 03, 2022 | Jan. 04, 2022 |
| Primer Application | | |
| Level 1 Stairway Wall | Jan. 05, 2022 | Jan. 06, 2022 |
| Wallpaper Application | | |

When the new work “Level 1 Stairway electrical fixture installation” is scheduled on 5 Jan. 2022, the trained AI model 110 identifies a schedule overlap between the two works, “Level 1 Stairway Wall Wallpaper Application”, and “Level 1 Stairway electrical fixture installation” as the works are operated on same location of the work, that is, Level1. The trained AI model generates the following notification to the user.

TABLE 5

| Activity | Start Date | End Date | |
|---|---|---|---|
| Level 1 Stairway Wall Surface | Jan. 01, 2022 | Jan. 02, 2022 | |
| Preparation | | | |
| Level 1 Stairway Wall Primer | Jan. 03, 2022 | Jan. 04, 2022 | |
| Application | | | |
| Level 1 Stairway Wall Wallpaper | Jan. 05, 2022 | Jan. 06, 2022 | [symbol] |
| Application | | | |
| Level 1 Stairway Wall Electrical | Jan. 05, 2022 | Jan. 06, 2022 | [symbol] |
| fixture installation | | | |

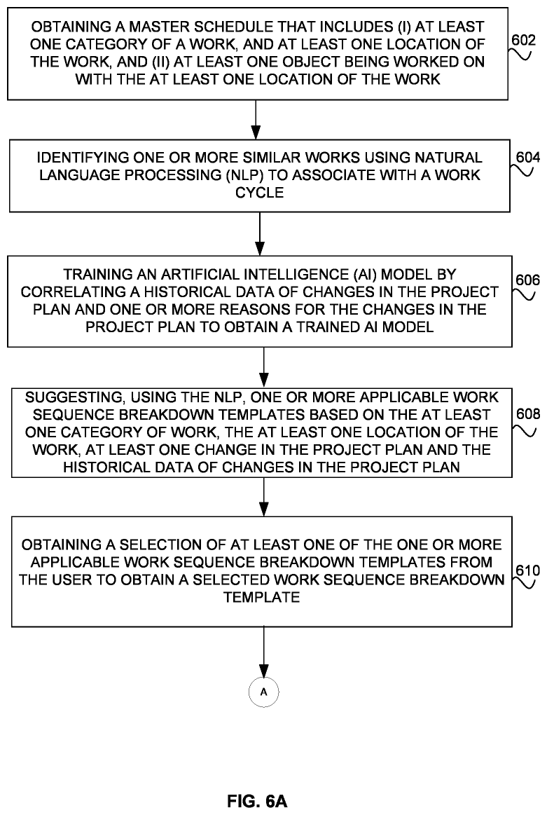

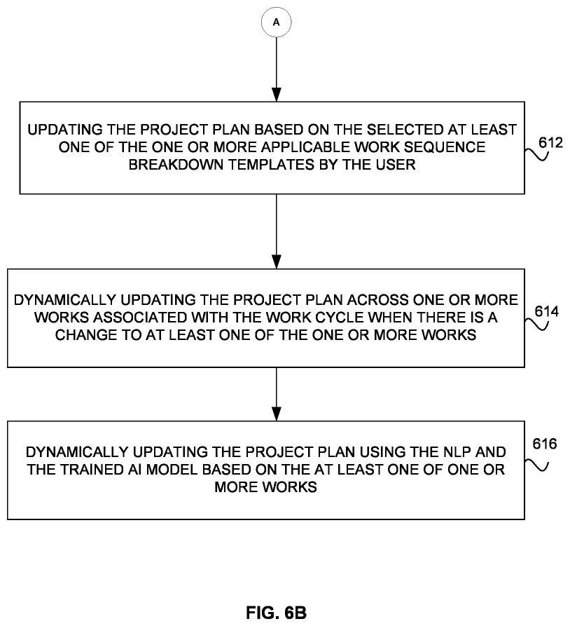

FIGS. 6A and 6B are flow diagrams that illustrate a method for dynamically updating a project plan using natural language processing and an artificial intelligence (AI) model according to some embodiments herein. At step 602, the method includes obtaining a master schedule that includes (a) at least one category of a work, and at least one location of the work, and (b) at least one object being worked on with the at least one location of the work. The at least one category of the work, the at least one location of the work and the at least one object being worked on are represented in a hierarchy. At step 604, the method includes identifying one or more similar works using the natural language processing to associate with a work cycle. At step 606, the method includes training the AI model by correlating a historical data of changes in the project plan and one or more reasons for the changes in the project plan to obtain a trained AI model. The historical data of changes in the project plan is stored in a knowledge base. At step 608, the method includes suggesting, using the natural language processing, one or more applicable work sequence breakdown templates based on the at least one category of the work, the at least one location of the work, at least one change in the project plan and the historical data of changes in the project plan.

At step 610, the method includes obtaining a selection of at least one of one or more applicable work sequence breakdown templates from the user to obtain a selected work sequence breakdown template. At step 612, the method includes updating the project plan based on the selected work sequence breakdown template. At step 614, The method includes dynamically updating the project plan across the plurality of works associated with the work cycle when there is a change to at least one of the plurality of works. At step 616, the method includes dynamically updating the project plan using the natural language processing and the trained AI model based on the change to the at least one of the one or more works.

Optionally, the method includes, identifying, using the natural language processing, at least one common structure type in a plurality of locations to group into the work cycle.

Optionally, the method includes obtaining at least one BIM component associated with the at least one category of the work from the master schedule to suggest the plurality of applicable work sequence breakdown templates using the natural language processing.

Optionally, the method includes ranking the suggested plurality of applicable work sequence breakdown templates based on a relevance obtained from the natural language processing of the at least one category of the work, and the at least one location of the work obtained from the master schedule.

In an exemplary embodiment, category of a work for example slab, and location of the work, for example, at level 1 and structure, for example, beams, are obtained from a master schedule. The category of the work, the location of the work and the object being worked on are represented in a hierarchy. One or more similar works, for example, pour concrete at different levels are identified using the natural language processing to associate with a work cycle.

The AI model correlates a historical data of changes in the project plan and one or more reasons for the changes in the project plan to obtain a trained AI model. The historical data of changes in the project plan is stored in a knowledge base. One or more applicable work sequence breakdown templates are suggested using the natural language processing based on the category of the work, the location of the work, a change in the project plan and the historical data of changes in the project plan.

The work sequence breakdown template includes for example, (i) beam rebar works followed by, precast slab (RC planks) followed by, beam PTT works followed by, slab top-up rebar followed by, M&E services followed by casting, (ii) slab/beam (precast system+post tensioning beam and precast slab)/cast in situ+precast, slab/beam (conventional formwork+post tension slab/beam/cast in situ, piling/cast in situ/4 number of piles, pile caps (>2 m)/cast in situ, pile caps (<2 m)/cast in situ. Once the user selects a suitable work sequence breakdown template, the project plan gets updated. The project plan gets dynamically updated when there is a change to one or more works.

If there is a delay in the work like slabs based on the estimated timelines, the trained AI model generates a recommendation of the constraint with a schedule for completion of the slabs. For example, delay due to wet weather may have constraint like providing a work team with waterproof gear.

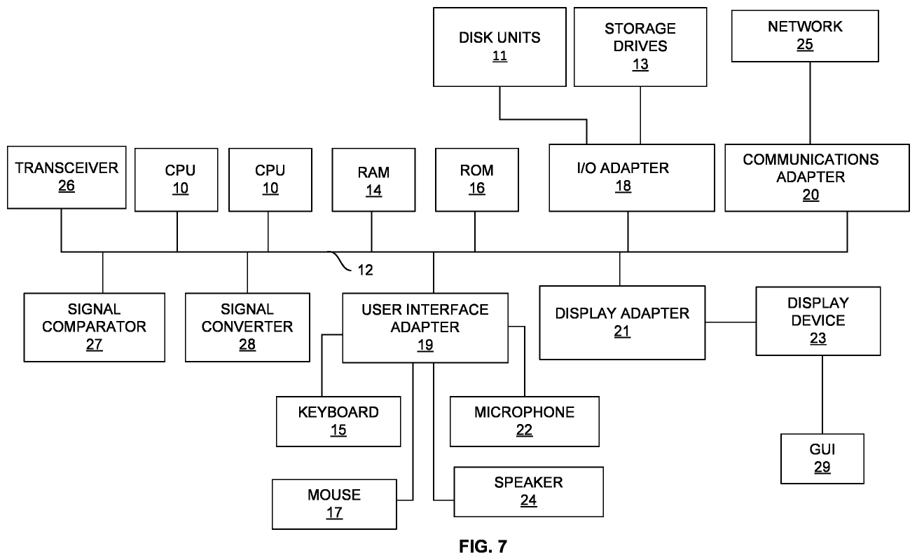

A representative hardware environment for practicing the embodiments herein is depicted in FIG. 7, with reference to FIGS. 1 through 6A and 6B. This schematic drawing illustrates a hardware configuration of a server 108/computer system/computing device in accordance with the embodiments herein. The system includes at least one processing device CPU 10 that may be interconnected via system bus 14 to various devices such as a random access memory (RAM) 12, read-only memory (ROM) 16, and an input/output (I/O) adapter 18. The V/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for dynamically updating a project plan using natural language processing and an artificial intelligence (AI) model, the method comprising:
obtaining a master schedule that comprises (a) at least one category of a work, and at least one location of the work, and (b) at least one object being worked on with the at least one location of the work, wherein the at least one category of the work, the at least one location of the work and the at least one object being worked on are represented in a hierarchy;
identifying a plurality of similar works using the natural language processing to associate with a work cycle;
training the AI model by correlating a historical data of changes in the project plan and a plurality of reasons for the changes in the project plan to obtain a trained AI model, wherein the historical data of changes in the project plan is stored in a knowledge base;
suggesting, using the natural language processing, a plurality of applicable work sequence breakdown templates based on the at least one category of the work, the at least one location of the work, at least one change in the project plan and the historical data of changes in the project plan;
obtaining a selection of at least one of the plurality of applicable work sequence breakdown templates from the user to obtain a selected work sequence breakdown template;
updating the project plan based on the selected work sequence breakdown template;
dynamically updating the project plan across the plurality of works associated with the work cycle when there is a change to at least one of the plurality of works; and
dynamically updating the project plan using the natural language processing and the trained AI model based on the change to the at least one of the plurality of works.

2. The processor-implemented method of claim 1, further comprising identifying, using the natural language processing, at least one common structure type in a plurality of locations to group into the work cycle.

3. The processor-implemented method of claim 1, further comprising obtaining at least one BIM component associated with the at least one category of the work from the master schedule to suggest the plurality of applicable work sequence breakdown templates using the natural language processing.

4. The processor-implemented method of claim 1, wherein the project plan comprises an estimated duration of completion of the work associated with the at least one location of the work, a production rate for the work associated with the at least one location, wherein the estimated duration of completion of the work is updated based on the trained AI model based on the change to the at least one of the plurality of the works.

5. The processor-implemented method of claim 1, wherein the historical data of changes in the project plan comprise at least one of a change in the work, a new task in the work cycle, a new constraint to a future task along with a schedule, changes in the schedule with possible space availability issues, delays due to planning errors, or a production rate for the task associated with the at least one location.

6. The processor-implemented method of claim 1, further comprising ranking the suggested plurality of applicable work sequence breakdown templates based on a relevance obtained from the natural language processing of the at least one category of the work, and the at least one location of the work obtained from the master schedule.

7. The processor-implemented method of claim 5, wherein the AI model is trained based on a historical data of a time schedule overlap of the work with another work at same location of the work, wherein the method further comprises dynamically updating the project plan based on space availability, using the trained AI model, with a notification when there is the time schedule overlap between works of the same location of the work.

8. The processor-implemented method of claim 1, further comprising dynamically updating the project plan, using the trained AI model, when the production rate for the work associated with the at least one location is applied to the work cycle by aggregating the production rate of the similar works in the work cycle.

9. The processor-implemented method of claim 6, further comprising providing, using a planning effectiveness indicator, a suggestion to the user w % ben there are delays due to planning errors by grouping the delays based on the at least one category of the work, wherein the planning effectiveness indicator includes a percentage of activities that are completed within a planned duration by the at least one category of the work, and a percentage of activities where start dates were delayed by the at least one category of the work with suggestions on planning improvements.

10. A system for dynamically updating a project plan using natural language processing and an artificial intelligence (AI) model, wherein the system comprises:
a memory that stores a set of instructions;
a processor that is configured to execute the set of instructions and is configured to
obtain a master schedule that comprises (a) at least one category of a work, and at least one location of the work, and (b) at least one object being worked on with the at least one location of the work, wherein the at least one category of the work, the at least one location of the work and the at least one object being worked on are represented in a hierarchy;
identifying a plurality of similar works using the natural language processing to associate with a work cycle;
train the AI model by correlating a historical data of changes in the project plan and a plurality of reasons for the changes in the project plan to obtain a trained AI model, wherein the knowledge base comprises the historical data of changes in the project plan is stored in a knowledge base;
suggest, using the natural language processing, a plurality of applicable work sequence breakdown templates based on the at least one category of the work, the at least one location of the work, at least one change in the project plan and the historical data of changes in the project plan;
obtain a selection of at least one of the plurality of applicable work sequence breakdown templates from the user to obtain a selected work sequence breakdown template;
update the project plan based on the selected at least one of the plurality of applicable work sequence breakdown template;
dynamically update the project plan across the plurality of works associated with the work cycle when there is a change to at least one of the plurality of works; and
dynamically update the project plan using the natural language processing and the trained AI model based on the change to the at least one of the plurality of works.

11. The system of claim 10, wherein the project plan comprises an estimated duration of completion of the work associated with the at least one location of the work, a production rate for the work associated with the at least one location, wherein the estimated duration of completion of the work is updated based on the trained AI model based on the change to the at least one of the plurality of the works.

12. The system of claim 10, wherein the historical data of changes in the project plan comprise at least one of a change in the work, a new task in the work cycle, a new constraint to a future task along with a schedule, changes in the schedule with possible space availability issues, delays due to planning errors, or a production rate for the task associated with the at least one location.

13. The system of claim 10, the processor is further configured to comprise identifying, using the natural language processing, at least one common structure type in a plurality of locations to group into the work cycle.

14. The system of claim 10, the processor is further configured to comprise ranking the suggested plurality of applicable work sequence breakdown templates based on a relevance obtained from the natural language processing of the at least one category of the work, and the at least one location of the work obtained from the master schedule.

15. The system of claim 10, wherein the AI model is trained based on a historical data of a time schedule overlap of the work with another work at same location of the work, wherein the processor is further configured to comprise dynamically updating the generated project plan based on space availability, using the trained AI model, with a notification when there is the time schedule overlap between works of the same location of the work.

16. The system of claim 10, the processor is further configured to dynamically updating the project plan, using the trained AI model, when the production rate for the work associated with the at least one location is applied to the work cycle by aggregating the production rate of the similar works in the work cycle.

17. The system of claim 10, the processor is further configured to comprise providing, using a planning effectiveness indicator, a suggestion to the user when there are delays due to planning errors by grouping the delays based on the at least one category of the work, wherein the planning effectiveness indicator includes a percentage of activities that are completed within a planned duration by the at least one category of the work, and a percentage of activities where start dates were delayed by the at least one category of the work with suggestions on planning improvements.

18. The system of claim 10, the processor further configured to comprise obtaining at least one BIM component associated with the at least one category of the work from the master schedule.

19. One or more non-transitory computer-readable storage mediums storing one or more sequences of instructions, which when executed by one or more processors, causes a method for dynamically updating a project plan using natural language processing and an artificial intelligence (AI) model performing steps of:
obtaining a master schedule that comprises (a) at least one category of a work, and at least one location of the work, and (b) at least one object being worked on with the at least one location of the work, wherein the at least one category of the work, the at least one location of the work and the at least one object being worked on are represented in a hierarchy;
identifying a plurality of similar works using the natural language processing to associate with a work cycle;
training the AI model by correlating a historical data of changes in the project plan and a plurality of reasons for the changes in the project plan to obtain a trained AI model, wherein the knowledge base comprises the historical data of changes in the project plan is stored in a knowledge base;
suggesting, using the natural language processing, a plurality of applicable work sequence breakdown templates based on the at least one category of the work, the at least one location of the work, at least one change in the project plan and the historical data of changes in the project plan;
obtaining a selection of at least one of the plurality of applicable work sequence breakdown templates from the user to obtain a selected work sequence breakdown template;
updating the project plan based on the selected at least one of the plurality of applicable work sequence breakdown templates by the user;
dynamically updating the project plan across the plurality of works associated with the work cycle when there is a change to at least one of the plurality of works; and
dynamically updating the project plan using the natural language processing and the trained AI model based on the change to the at least one of the plurality of works.
